(19) United States
(12) Patent Application Publication
(10) Pub. No.: US 2006/0292467 A1
(43) Pub. Date: Dec. 28, 2006

(54) Electrophotographic photoreceptor containing electron transporting material in a charge generating layer

(75) Inventors: Beom-jun Kim, Yongin-si (KR); Seung-ju Kim, Suwon-si (KR); Saburo Yokota, Suwon-si (KR); Kyung-yol Yon, Seongnam-si (KR); Moto Makino, Suwon-si (KR); Hwan-koo Lee, Suwon-si (KR); Ji-young Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/390,359

(22) Filed: Mar. 28, 2006

(30) Foreign Application Priority Data
Jun. 24, 2005 (KR) 10-2005-0054943

(51) Int. Cl. G03G 5/047

(52) U.S. Cl. 430/58.25; 430/59.5; 399/159

(57) ABSTRACT

An electrophotographic photoreceptor includes an electron transporting material in a charge-generating layer. The electrophotographic photoreceptor includes a conductive substrate; a charge generating layer formed on the conductive substrate and includes a charge generating material and electron transporting material; and a charge transporting layer formed on the charge generating layer and includes a charge transporting material, wherein the electron transporting material is a phenylazomethylene-cyclohexadienone derivative represented by the following Formula I: 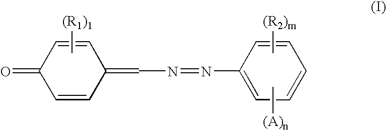
wherein R₁ and R₂ are independently selected from the group consisting of a substituted or unsubstituted C₁-C₂₀ alkyl, substituted or unsubstituted C₁-C₂₀ alkoxy, substituted or unsubstituted C₆-C₃₀ aryl, substituted or unsubstituted C₇-C₃₀ aralkyl and a halogen; A is selected from the group consisting of nitro, cyano and sulfone; 1 is an integer between 1 and 4; m is 0 or an integer between 1 and 4; and n is an integer between 1 and 5. The electrophotographic photoreceptor shows high sensitivity and low exposure potential.

### CROSS-REFERENCE TO RELATED APPLICATIONS

This application claims benefit under 35 U.S.C. § 119 from Korean Patent Application No. 2005-54943, filed on Jun. 24, 2005, the entire contents of which is herein incorporated by reference.

### BACKGROUND OF THE INVENTION

1. Field of the Invention

The present invention relates to an electrophotographic photoreceptor. More particularly, the present invention relates to an electrophotographic photoreceptor having improved electrical properties that contains as electron transporting material (ETM), a phenylazomethylene-cyclohexadienone derivative in a charge-generating layer.

2. Description of the Related Art

Electrophotographic photoreceptors are used in electrophotographic image forming devices such as facsimiles, copiers and laser printers. In general, an electrophotographic photoreceptor includes a photosensitive layer formed on a conductive substrate, wherein the photosensitive layer includes a charge generating material (CGM), a charge transporting material (CTM) and binder resins. Charge generating materials that may be used in the photosensitive layer are classified broadly into organic compounds and inorganic compounds. Recently, organic compounds are widely used as charge generating materials due to concerns over environmental pollution. Therefore, the photoreceptor is sometimes referred to as an organic photoreceptor.

Photoreceptors may be classified, according to their structures, into monolayer photoreceptors where a charge generating material and charge transporting material are dispersed in a single layer, and multi-layer photoreceptors where a charge generating layer containing a charge generating material and a charge transporting layer containing a charge transporting material are laminated together. While a monolayer photoreceptor must satisfy a set of electrical properties with a single layer, a multi-layer photoreceptor includes multiple layers each having a separate function. Thus, it is possible to design electrical properties individually such as charging potential and exposure potential. Particularly, a multi-layer photoreceptor is advantageous in that it permits stable application of an electric field to a thin coating film, and thus retains a greater quantity of electric charges under the same electric field strength to allow development with a great amount of toner. Therefore, such multi-layer photoreceptors are widely used. A multi-layer photoreceptor may further include additional layers having specific functions. For example, the photoreceptor can include an intermediate layer to enhance adhesion between conductive substrate and photosensitive layers and to prevent charge injection from a substrate. The photoreceptor can also include a protective layer on top of the photosensitive layer.

Meanwhile, a general electrophotographic image forming process is accomplished as follows. First, a photosensitive material is electrically charged and is exposed to an image-forming light source to form electrostatic latent images. Then, an electric potential for development is applied thereto to permit development of a toner image. The toner image is then transferred to a recording medium such as paper, and the image is formed and fixed in the recording medium.

As electrophotographic image forming devices pursue an increasingly high processing speed, it is necessary to improve the sensitivity of electrophotographic photoreceptors, and to control an increase in the exposure potential and residual potential during repeated electrophotographic processes.

FIG. 1 is a schematic view showing a bilayer type electrophotographic photoreceptor according to the prior art. More particularly, a charge-generating layer 200 is formed on a conductive substrate 300, and a charge-transporting layer 100 is formed on the charge-generating layer 200. Generally, in the case of a bilayer organic photoreceptor, a high-sensitivity organic photoreceptor can be obtained by increasing the proportion of a charge generating material in the composition for a charge-generating layer. However, when the amount of a charge generating material increases, stability of a coating solution for the charge-generating layer is deteriorated, resulting in poor coating quality and weak adhesion between the substrate and the charge transporting layer, even though improved electrical properties can be obtained such as high sensitivity and low exposure potential. On the other hand, when the amount of the charge generating material decreases, mechanical properties improve, such as the stability of a coating solution for the charge-generating layer, the coating quality and adhesion of the charge generating layer/conductive substrate and charge generating layer/charge transporting layer, while the sensitivity of the photoreceptor is degraded and exposure potential increases. When the thickness of a charge generating layer is increased to improve the sensitivity, it is difficult for the electrons generated from the charge generating material to move toward the conductive substrate. Accordingly, charge generation cannot be made smoothly, resulting in a drop in sensitivity and an increase in exposure potential.

Japanese Laid-Open Patent Nos. 2000-147806, 2000-330306, 2002-221809 and 2000-199979 disclose an electrophotographic photoreceptor that comprises an electron transporting material in a single-layer photoreceptor formed of a charge generating material and charge transporting material on a conductive substrate. According to the above-mentioned publications, it is possible to improve electrostatic properties of photoreceptors. However, the problems related with coating solution stability and degradation of adhesion still remains unsolved. U.S. Pat. Nos. 5,547,790, 5,667,094 and 5,571,648 disclose bilayer type organic photoreceptors having improved electrical and mechanical properties, which comprise a polymeric charge transporting material, particularly a hole transporting material added to a charge generating layer, an intermediate layer or a protective layer. According to the above U.S. patent publications, it is necessary to increase the contact between the charge generating material and charge transporting material to generate electric charges sufficiently in the charge-generating layer. To do this, a polymeric hole transporting material is added to the charge-generating layer. However, the organic photoreceptors are yet to be further improved, because their sensitivity is not sufficient to conform to an increased processing speed of a printer. In addition, the exposure potential and residual potential characteristics during repeated electrophotographic processes are not satisfactory for the known organic photoreceptors. Additionally, because electron-transporting capability of an electron transporting material that is widely and currently used is lower than hole transporting capability of a hole transporting material by at least 100 times, quality of a photoreceptor is greatly affected by electron transporting capability of an electron transporting material. Therefore, it is necessary to reinforce electron-transporting capability to improve the quality of a photoreceptor.

### SUMMARY OF THE INVENTION

Therefore, the present invention has been made to address the above-mentioned problems. An object of the present invention is to provide an electrophotographic photoreceptor having high sensitivity and low exposure potential, which contains an electron transporting material in a charge generating layer. The photoreceptor of the invention transports electrons generated from the charge generating material to a conductive substrate promptly and smoothly, and facilitates electron injection from the charge generating layer to the conductive substrate, while not inhibiting mechanical properties such as coating stability and adhesion of the charge generating layer.

Another object of the present invention is to provide an electrophotographic image forming device and an electrophotographic image forming method using the above electrophotographic photoreceptor, so as to improve sensitivity in line with an increase in processing speed of a printer and to inhibit an increase in exposure potential and residual potential efficiently during repeated electrophotographic processing steps.

In order to accomplish the above objects, an aspect of the present invention provides an electrophotographic photoreceptor, which comprises: a conductive substrate; a charge generating layer formed on the conductive substrate and comprising a charge generating material and an electron transporting material; and a charge transporting layer formed on the charge generating layer and comprising a charge transporting material, wherein the electron transporting material is a phenylazomethylene-cyclohexadienone derivative represented by the following formula:

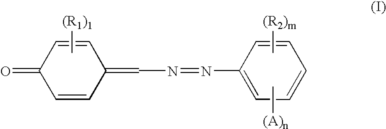

wherein each of R₁ and R₂ are independently selected from the group consisting of a substituted or unsubstituted C₁-C₂₀ alkyl, substituted or unsubstituted C₁-C₂₀ alkoxy, substituted or unsubstituted C₆-C₃₀ aryl, substituted or unsubstituted C₇-C₃₀ aralkyl and a halogen; A is selected from the group consisting of nitro, cyano and sulfone; 1 is an integer between 1 and 4; m is 0 or an integer between 1 and 4; and n is an integer between 1 and 5.

The electrophotographic photoreceptor according to one embodiment of the present invention, preferably includes TiOPc (titanyloxy phthalocyanine) as a charge generating material.

The electrophotographic photoreceptor according to an embodiment of the present invention, more preferably includes a y-type TiOPc as the charge generating material.

The electrophotographic photoreceptor according to an embodiment of the present invention, includes a phenylazomethylene-cyclohexadienone derivative of the Formula I in which A is a nitro group as the electron transporting material.

The electrophotographic photoreceptor according to another embodiment of the present invention, includes a phenylazomethylene-cyclohexadienone derivative of Formula I in which A is a cyano group as the electron transporting material.

The electrophotographic photoreceptor according to still another embodiment of the present invention, includes a phenylazomethylene-cyclohexadienone derivative of Formula I in which A is a sulfone group as the electron transporting material.

The electrophotographic photoreceptor according to an embodiment of the present invention, includes a charge generating material present in a charge-generating layer in an amount of about 40-60 wt % based on the total weight of charge generating layer.

The electrophotographic photoreceptor according to an embodiment of the present invention, includes an electron transporting material present in a charge generating layer in an amount of about 5 and 17 wt % based on the total weight of charge generating layer.

The electrophotographic photoreceptor according to an embodiment of the present invention, preferably includes a hole transporting material as the charge transporting material.

The electrophotographic photoreceptor according to an embodiment of the present invention further includes an intermediate layer interposed between the conductive substrate and charge-generating layer.

The electrophotographic photoreceptor according to an embodiment of the present invention is a negatively charged bilayer photoreceptor.

According to another aspect of the present invention, an electrophotographic image forming device is provided, which comprises: (a) a plurality of supporting rollers; and (b) an electrophotographic photoreceptor mounted in a manner to operate in line with operation of the supporting rollers, wherein the electrophotographic photoreceptor comprises: a conductive substrate; a charge generating layer formed on the conductive substrate and comprising a charge generating material and electron transporting material; and a charge transporting layer formed on the charge generating layer and comprising a charge transporting material, and the electron transporting material is a phenylazomethylene-cyclohexadienone derivative represented by the following formula:

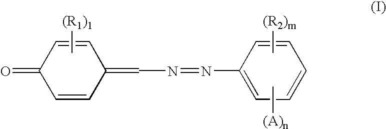

wherein each of R₁ and R₂ are independently selected from the group consisting of a substituted or unsubstituted C₁-C₂₀ alkyl, substituted or unsubstituted C₁-C₂₀ alkoxy, substituted or unsubstituted C₆-C₃₀ aryl, substituted or unsubstituted C₇-C₃₀ aralkyl and a halogen; A is any one selected from the group consisting of nitro, cyano and sulfone; 1 is an integer between 1 and 4; m is 0 or an integer between 1 and 4; and n is an integer between 1 and 5.

According to still another aspect of the present invention, a method for forming an electrophotographic image comprises the steps of: (a) applying electric potential to the surface of an electrophotographic photoreceptor; (b) exposing the surface of the electrophotographic photoreceptor to radiation to dissipate the electric charges in selected zones by image, to form a pattern having a charged zone and non-charged zone on the surface; (c) contacting the patterned surface with a toner to form a toner image; and (d) transferring the toner image to a support, wherein the electrophotographic photoreceptor comprises: a conductive substrate; a charge generating layer formed on the conductive substrate and comprising a charge generating material and electron transporting material; and a charge transporting layer formed on the charge generating layer and comprising a charge transporting material, and the electron transporting material is a phenylazomethylene-cyclohexadienone derivative represented by the following formula:

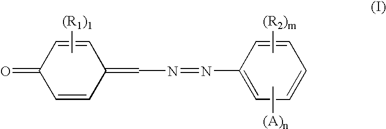

wherein each of R₁ and R₂ are independently selected from the group consisting of a substituted or unsubstituted C₁-C₂₀ alkyl, substituted or unsubstituted C₁-C₂₀ alkoxy, substituted or unsubstituted C₆-C₃₀ aryl, substituted or unsubstituted C₇-C₃₀ aralkyl and a halogen; A is selected from the group consisting of nitro, cyano and sulfone; 1 is an integer between 1 and 4; m is 0 or an integer between 1 and 4; and n is an integer between 1 and 5.

These and other salient feature of the invention will become apparent from the following detailed description of the invention which, taken in conjunction with the annexed drawings, disclose various embodiments of the invention.

### BRIEF DESCRIPTION OF THE DRAWINGS

The above aspects and features of the present invention will be more apparent by describing certain embodiments of the present invention with reference to the accompanying drawings, in which:

FIG. 1 is a schematic sectional view showing a bilayer electrophotographic photoreceptor according to the prior art; and

FIG. 2 is a schematic sectional view showing a multi-layer electrophotographic photoreceptor according to an embodiment of the present invention.

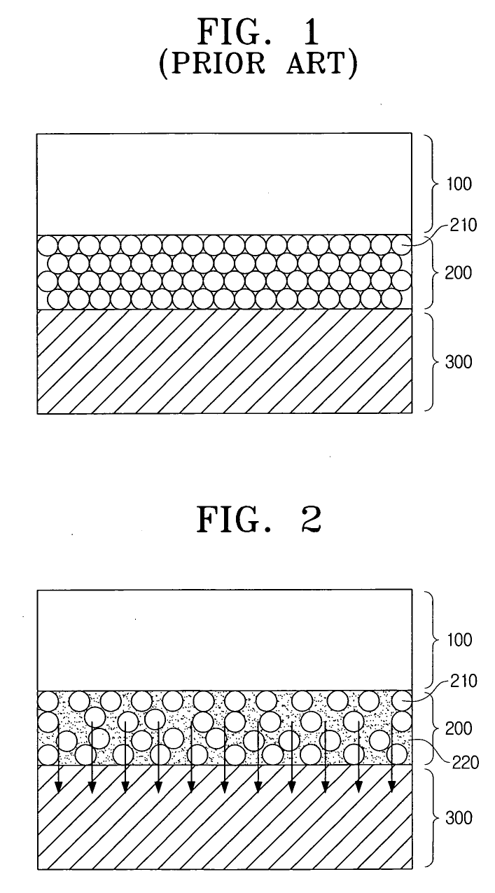

### DETAILED DESCRIPTION OF THE PREFERRED EMBODIMENTS

Hereinafter, the present invention will be explained in more detail with reference to the accompanying drawings and embodiments. In the following description, the same elements will be designated by the same reference numerals.

In the electrophotographic photoreceptor according to an embodiment of the present invention, the conductive substrate should be a material with electroconductivity. Materials that may be used in the conductive substrate include: metals such as aluminum, copper, tin, platinum, gold, silver, vanadium, molybdenum, chrome, cadmium, titanium, nickel, indium, stainless steel and brass; plastic materials to which the metals are deposited or laminated; and glass coated with aluminum iodide, tin oxide or indium oxide, but are not limited thereto. The above materials may be formed into drums or belts to be used as conductive substrates.

In the electrophotographic photoreceptor according to an embodiment of the present invention, the charge generating material refers to a material that absorbs light to produce charge carriers. Compounds suitable for the charge generating material of the charge generating layer according to an embodiment of the present invention include metal-free phthalocyanine, or metal phthalocyanine such as titanium phthalocyanine, copper phthalocyanine, titanyloxy phthalocyanine and hydroxygallium phthalocyanine, but are not limited thereto. Preferably, the charge generating material in the present invention is titanyloxy phthalocyanine (TiOPC). More preferably, the charge generating material is y-type TiOPC. When the charge generating material is present in the charge-generating layer at a high concentration, the coating solution stability decreases, resulting in degradation of coating quality, even if electrical properties are improved. Also, adhesion between the charge generating layer and conductive substrate, as well as between the charge generating layer and charge transporting layer decrease, so that both printing quality and photoreceptor drum service life are degraded in a high-speed electrophotographic image-forming device. Even though the above problems may be solved by using the charge generating material in an amount of about 40-60-wt % based on the total weight of charge generating layer, there are still other problems such as exposure potential growth and sensitivity deterioration. However, when an electron transporting material is added to the charge generating layer of a negatively charged bilayer organic photoreceptor while reducing the amount of charge generating material, the electron transporting material enhances transport of electrons to the conductive substrate, and increases charge generation at the same time, thereby improving the sensitivity.

FIG. 2 is a schematic sectional view showing a multi-layer electrophotographic photoreceptor according to an embodiment of the present invention. As shown in FIG. 2, electrons generated by the charge generating material 210 in the charge-generating layer 200 move along the direction illustrated by arrows from the charge-generating layer 200 to the conductive substrate 300 via the electron transporting material 220. In the electrophotographic photoreceptor comprising the electron transporting material in the charge generating layer according to an embodiment of the present invention, the charge generating material 210 is present in the charge generating layer 200 preferably in an amount of about 40-60 wt % based on the total weight of charge generating layer. The electrophotographic image forming device of the invention includes a plurality of supporting rollers as known in the art and the electrophotographic photoreceptor is mounted within the image forming device to operate in line with the supporting rollers.

The electrophotographic photoreceptor is used in an electrophotographic image forming device to produce an electrophotographic image. The method of forming the electrophotographic image includes the steps of applying an electric potential to the surface of the electrophotographic photoreceptor. The surface of the electrophotographic photoreceptor is exposed to radiation to dissipate the electric charges in selected zones by imaging to form a pattern having a charged zone and a non-charged zone on the surface to form a latent image. A toner is then applied to form a toner image which is then transferred to a support such as paper.

The electron transporting material used in the present invention is a phenylazomethylene-cyclohexadienone derivative, which is disclosed in Korean Patent Application No. 2003-0091437 of the present inventors and used in a positively charged monolayer organic photoreceptor. Specific examples of the phenylazomethylene-cyclohexadienone derivative that may be used in the present invention include compounds represented by the following formulae 1 through 18, but are not limited thereto:

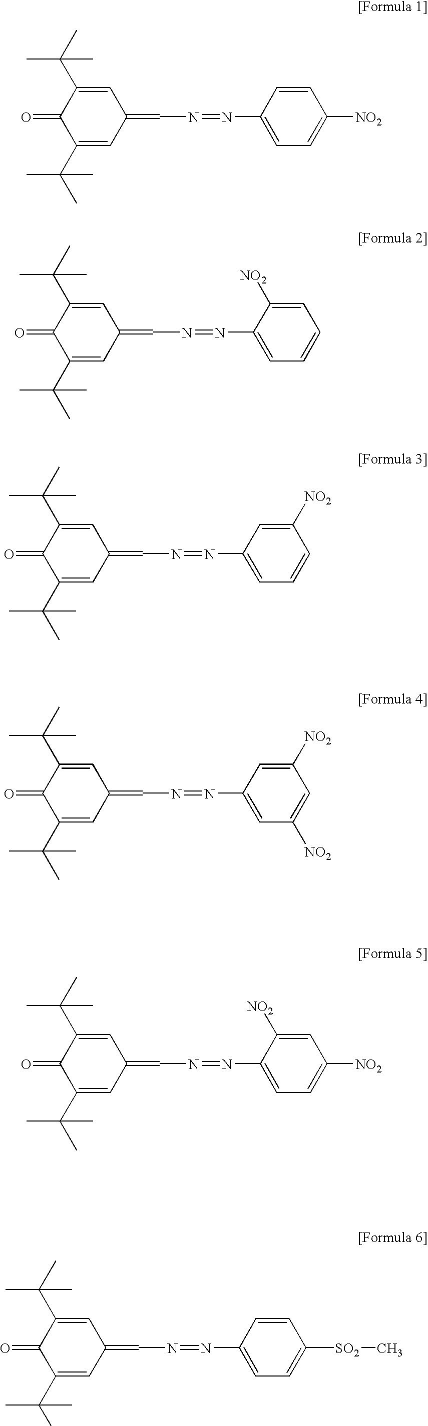

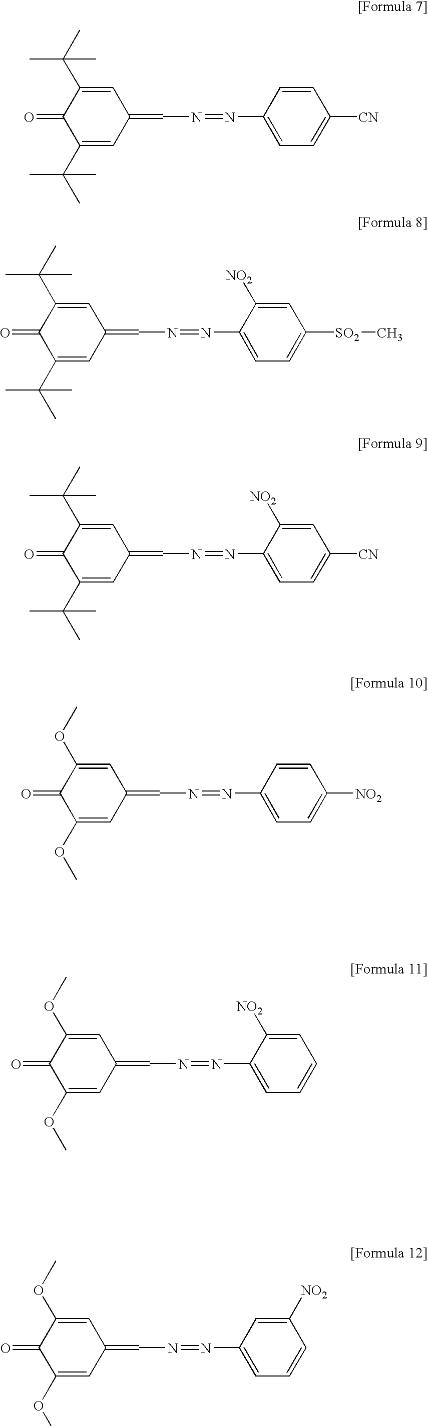

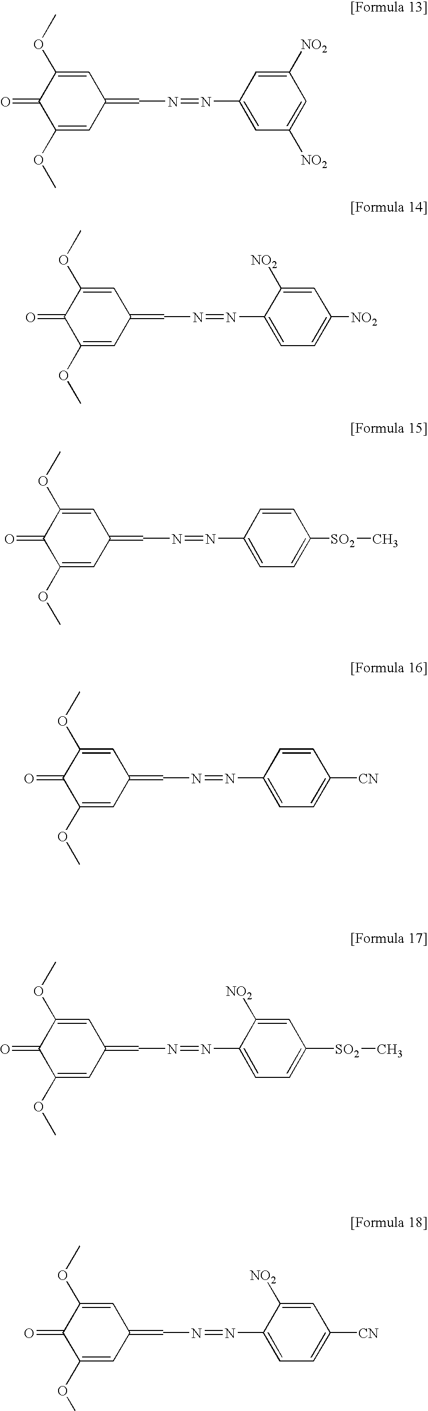

When the electron transporting material is present in the charge-generating layer in an amount of less than about 5 wt %, it is not possible to improve electrical properties to a sufficient degree. When the amount of electron transporting material is higher than about 17 wt %, the amount of charge generating material decreases accordingly and sufficient charge generation cannot be obtained, resulting in degradation of electrostatic properties. Therefore, it is preferred that the electron transporting material is present in the charge-generating layer in an amount of about 5-17 wt % based on the total weight of charge generating layer.

The charge transporting material used in the present invention is a hole transporting material.

The hole transporting material that may be used in the present invention includes nitrogen-containing cyclic compounds or condensed multicyclic compounds such as pyrene-, carbazole-, hydrazone-, oxazole-, oxadiazole-, pyrazoline-, arylamine-, arylmethane-, benzydine-, thiazole-, and styryl-based compounds. Also, polymers or polysilane compounds having such groups in a backbone or side chain as substituents may also be used. However, the scope of the present invention is not limited to the above examples for the hole transporting material.

The charge generating material and charge transporting material contained in the photosensitive layer are dispersed in one or more binder resins. Preferably, the binder resin that may be used in the present invention is an electrically insulating polymer. Examples of the binder resin include, but are not limited to, polyvinyl butyrals, polycarbonates, polyesters, methacrylic resins, acrylic resins, polyvinyl chlorides, polyvinylidene chlorides, polystyrenes, polyvinyl acetates, silicone-alkyd resins, styrene-alkyd resins, poly-N-vinylcarbazoles, phenoxy resins, epoxy resins, polyvinyl acetals, polyvinyl formals, polysulfones, polyvinyl alcohols, ethyl celluloses, phenolic resins, polyamides, carboxy-ethyl celluloses, polyurethanes, or the like. These polymers may be used alone or in combination.

Furthermore, it is preferred that the electrophotographic photoreceptor according to an embodiment of the present invention further comprises an intermediate layer between the conductive substrate and the photosensitive layer in order to improve adhesion between the layers and to prevent the holes from being fluxed into the photosensitive layer from the conductive substrate.

In one preferred embodiment of the present invention, the electrophotographic photoreceptor according to an is a negatively charged multi-layer organic photoreceptor.

The operating mechanism of a negatively charged bilayer electrophotographic photoreceptor is as follows. When laser beams are irradiated to the surface of a photoreceptor charged with negative electric charges, positive and negative electric charges are generated in the charge-generating layer. Herein, due to an electric field applied to the photoreceptor, negative charges (electrons) move to the conductive substrate, while positive charges (holes) move to the surface of the photoreceptor following their entry into a charge-transporting layer, so that surface charges can be neutralized. Then, surface potential is changed at the exposed portion forming a latent image, and the latent image zone is subjected to development. According to the electrophotographic photoreceptor of the present invention, the charge generating layer comprises an electron transporting material, so that electron transport to the conductive substrate can be facilitated. Thus, charge generation by the charge generating material can be enhanced, resulting in improvement of overall electrical properties including sensitivity and exposure potential.

Reference will now be made in detail to the examples of the present invention. It is to be understood that the following examples are illustrative only and that the present invention is not limited thereto.

Preparation of Electrophotographic Photoreceptor

### EXAMPLE 1

| | Amount |
|---|---|
| | (parts by weight) |
| Charge Generating Material (CGM): y-type | 20 |
| Titanyloxy phthalocyanine (y-TiOPc) | |
| Electron Transporting Material (ETM): | 2 |
| compound of the above formula 1 | |
| Binder Resin: Polyvinyl butyral (PVB) | 13 |
| Solvent: Tetrahydrofuran (THF) | 635 |

The above components were mixed, sand milled for 2 hours and dispersed by ultrasonic waves to form a coating solution for a charge generating layer. The coating solution obtained as described above was coated on an anodized aluminum drum, and the coated drum was dried at 120° C. for 20 minutes to provide a charge generating layer.

| | Amount |
|---|---|
| | (parts by weight) |
| Hole Transporting Material: | 45 |
| compound of the following formula 19 | |
| Binder Resin: Polycarbonate (PCZ) | 55 |
| Solvent: THF/toluene (4:1 (v:v) mixed solvent) | 426 |

The above components were mixed and dissolved, and the resulting mixture was coated on the preformed charge-generating layer. Then, the resulting structure was dried at 120° C. for 30 minutes to provide a charge transporting layer. The bilayer organic photoreceptor had a thickness of about 20 μm.

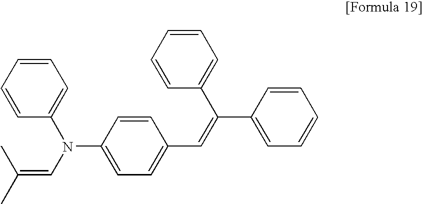

### EXAMPLE 2

| | Amount |
|---|---|
| | (parts by weight) |
| Charge Generating Material: y-TiOPc | 20 |
| Electron Transporting Material: | 5 |
| compound of the above formula 1 | |
| Binder Resin: Polyvinyl butyral (PVB) | 13 |
| Solvent: Tetrahydrofuran (THF) | 635 |

The above components were mixed, sand milled for 2 hours and dispersed by ultrasonic waves to form a coating solution for forming a charge generating layer. The coating solution obtained as described above was coated on an anodized aluminum drum, and the coated drum was dried at 120° C. for 20 minutes to provide a charge generating layer.

| | Amount |
|---|---|
| | (parts by weight) |
| Hole Transporting Material: | 45 |
| compound of the above formula 19 | |
| Binder Resin: Polycarbonate (PCZ) | 55 |
| Solvent: THF/toluene (4:1 (v:v) mixed solvent) | 426 |

The above components were mixed and dissolved, and the resulting mixture was coated on the preformed charge-generating layer. Then, the resulting structure was dried at 120° C. for 30 minutes to provide a charge transporting layer. The bilayer organic photoreceptor had a thickness of about 20 μm.

### EXAMPLE 3

| | Amount |
|---|---|
| | (parts by weight) |
| Charge Generating Material: y-TiOPc | 20 |
| Electron Transporting Material: | 7 |
| compound of the above formula 1 | |
| Binder Resin: Polyvinyl butyral (PVB) | 13 |
| Solvent: Tetrahydrofuran (THF) | 635 |

The above components were mixed, sand milled for 2 hours and dispersed by ultrasonic waves to form a coating solution for forming a charge generating layer. The coating solution obtained as described above was coated on an anodized aluminum drum, and the coated drum was dried at 120° C. for 20 minutes to provide a charge generating layer.

| | Amount |
|---|---|
| | (parts by weight) |
| Hole Transporting Material: | 45 |
| compound of the above formula 19 | |
| Binder Resin: Polycarbonate (PCZ) | 55 |
| Solvent: THF/toluene (4:1 (v:v) mixed solvent) | 426 |

The above components were mixed and dissolved, and the resulting mixture was coated on the preformed charge-generating layer. Then, the resulting structure was dried at 120° C. for 30 minutes to provide a charge transporting layer. The bilayer organic photoreceptor had a thickness of about 20 μm.

### COMPARATIVE EXAMPLE 1

| | Amount |
|---|---|
| | (parts by weight) |
| Charge Generating Material: y-TiOPc | 20 |
| Binder Resin: polyvinyl butyral (PVB) | 18 |
| Solvent: tetrahydrofuran (THF) | 635 |

The above components were mixed, sand milled for 2 hours and dispersed by ultrasonic waves to form a coating solution for forming a charge generating layer. The coating solution obtained as described above was coated on an anodized aluminum drum, and the coated drum was dried at 120° C. for 20 minutes to provide a charge generating layer.

| | Amount |
|---|---|
| | (parts by weight) |
| Hole Transporting Material: | 45 |
| compound of the above formula 19 | |
| Binder Resin: Polycarbonate (PCZ) | 55 |
| Solvent: THF/toluene (4:1 (v:v) mixed solvent) | 426 |

The above components were mixed and dissolved, and the resulting mixture was coated on the preformed charge-generating layer. Then, the resulting structure was dried at 120° C. for 30 minutes to provide a charge transporting layer. The bilayer organic photoreceptor had a thickness of about 20 μm.

### COMPARATIVE EXAMPLE 2

| | Amount |
|---|---|
| | (parts by weight) |
| Charge Generating Material: y-TiOPc | 20 |
| Binder Resin: Polyvinyl butyral (PVB) | 13 |
| Solvent: Tetrahydrofuran (THF) | 635 |

The above components were mixed, sand milled for 2 hours and dispersed by ultrasonic waves to form a coating solution for forming a charge generating layer. The coating solution obtained as described above was coated on an anodized aluminum drum, and the coated drum was dried at 120° C. for 20 minutes to provide a charge generating layer.

| | Amount |
|---|---|
| | (parts by weight) |
| Hole Transporting Material: | 45 |
| compound of the above formula 19 | |
| Binder Resin: Polycarbonate (PCZ) | 55 |
| Solvent: THF/toluene (4:1 (v:v) mixed solvent) | 426 |

The above components were mixed and dissolved, and the resulting mixture was coated on the preformed charge-generating layer. Then, the resulting structure was dried at 120° C. for 30 minutes to provide a charge transporting layer. The bilayer organic photoreceptor had a thickness of about 20 μm.

### COMPARATIVE EXAMPLE 3

| | Amount |
|---|---|
| | (parts by weight) |
| Charge Generating Material: y-TiOPc | 20 |
| Electron Transporting Material: | 7 |
| compound of the above formula 1 | |
| Binder Resin: Polyvinyl butyral (PVB) | 13 |
| Solvent: Tetrahydrofuran (THF) | 635 |

The above components were mixed, sand milled for 2 hours and dispersed by ultrasonic waves to form a coating solution for forming a charge generating layer. The coating solution obtained as described above was coated on an anodized aluminum drum, and the coated drum was dried at 120° C. for 20 minutes to provide a charge generating layer.

| | Amount |
|---|---|
| | (parts by weight) |
| Hole Transporting Material: | 45 |
| compound of the above formula 20 | |
| Binder Resin: Polycarbonate (PCZ) | 55 |
| Solvent: THF/toluene (4:1 (v:v) mixed solvent) | 426 |

The above components were mixed and dissolved, and the resulting mixture was coated on the preformed charge-generating layer. Then, the resulting structure was dried at 120° C. for 30 minutes to provide a charge transporting layer. The bilayer organic photoreceptor had a thickness of about 20 μm.

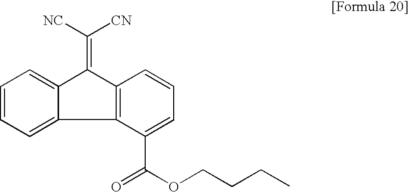

Test

Electrophotographic properties of each photoreceptor were determined using a drum photoreceptor evaluation system (available from QEA Co., PDT-2000). A voltage was applied to obtain a charged potential of 800V, and each drum photoreceptor was charged under the condition of a relative velocity of a charger to photoreceptor of 100 mm/sec. Right after this, the photoreceptor was irradiated with monochromatic light with a wavelength of 780 nm. Post-exposure surface potential values were measured and the relationship between energy and surface potential was obtained. The results are shown in the following Table 1.

TABLE 1

| | CGM | Binder | ETM | | | | |
|---|---|---|---|---|---|---|---|
| | (parts by | (parts by | (parts by | | | | |
| | weight) | weight ) | weight) | E1/2 | E200 | E0.25 | E0.5 |
| Ex. 1 | 20 | 13 | 2 | 0.096 | 0.156 | 71 | 29 |
| Ex. 2 | 20 | 13 | 5 | 0.094 | 0.154 | 63 | 25 |
| Ex. 3 | 20 | 13 | 7 | 0.095 | 0.155 | 64 | 27 |
| Comp. | 20 | 18 | 0 | 0.098 | 0.162 | 104 | 57 |
| Ex. 1 | | | | | | | |
| Comp. | 20 | 13 | 0 | 0.099 | 0.160 | 79 | 35 |
| Ex. 2 | | | | | | | |
| Comp. | 20 | 13 | 5 | 0.104 | 0.187 | 112 | 65 |
| Ex. 3 | | | | | | | |

In Table 1, E½ (J/cm²) means energy where sensitivity and surface potential is reduced to half of the initial values, E200 (μJ/cm²) means light energy required to reach a surface potential of 200V, E0.25 means a surface potential obtained when a light energy of 0.25 μJ/cm² is irradiated, and E0.5 means a surface potential obtained when a light energy of 0.5 μJ/cm² is irradiated.

In Examples 1 to 3, E½, E200, E0.25 and E0.5 values are lower than those of Comparative Examples 1 and 2. In particular, the organic photoreceptor according to Example 2, which comprises the charge generating material in the same proportion as Comparative Example 1 and uses as electron transporting material in the charge generating layer a phenylazomethylene-cyclohexadienone derivative (compound of the above formula 1), shows lower values of E½ and E200 and significantly lower values of E0.25 and E 0.5, than those of the corresponding photoreceptor free of electron transporting material (Comparative Example 1). It seems that E0.25 and E0.5 values decreased because the electrons generated in the charge generating layer flow smoothly via the electron transporting material and such smooth electron flow enhances charge generation.

On the other hand, the organic photoreceptor according to Comparative Example 3 using a different electron transporting material (compound of the above Formula 20) cannot provide any improvement in electrical properties.

Therefore, it can be recognized that electrophotographic photoreceptors comprising a phenylazomethylene-cyclohexadienone as electron transporting material according to Examples 1 to 3 provide improved electrical properties.

As described above, the electrophotographic photoreceptor according to an embodiment of the present invention can provide excellent electrostatic properties including improved sensitivity and decreased exposure potential, because the electrons generated in the charge generating layer flow smoothly through the electron transporting material and such smooth electron flow enhances charge generation in spite of a reduced amount of charge generating material.

While the invention has been shown and described with reference to certain embodiments thereof, it will be appreciated that changes, modification and variations ca be made without departing from the spirit and scope of the inventive concept disclosed herein. Accordingly, it is intended to embrace all such changes, modification and variations that fall within the sprint and scope of the appended claims.

What is claimed is:

1. An electrophotographic photoreceptor comprising:
a conductive substrate;
a charge generating layer formed on the conductive substrate and comprising a charge generating material and an electron transporting material; and
a charge-transporting layer formed on the charge generating layer and comprising a charge transporting material,
wherein the electron transporting material is a phenylazomethylene-cyclohexadienone derivative represented by the following Formula I: 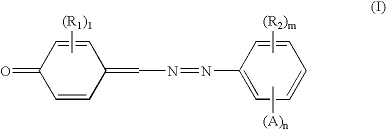
wherein R₁ and R₂ are independently selected from the group consisting of a substituted or unsubstituted C₁-C₂₀ alkyl, substituted or unsubstituted C₁-C₂₀ alkoxy, substituted or unsubstituted C₆-C₃₀ aryl, substituted or unsubstituted C₇-C₃₀ aralkyl and a halogen; A is selected from the group consisting of nitro, cyano and sulfone; 1 is an integer between 1 and 4; m is 0 or an integer between 1 and 4; and n is an integer between 1 and 5.

2. The electrophotographic photoreceptor as claimed in claim 1, wherein the charge generating material is TiOPc (titanyloxy phthalocyanine).

3. The electrophotographic photoreceptor as claimed in claim 1, wherein the charge generating material is y-type TiOPc.

4. The electrophotographic photoreceptor as claimed in claim 1, wherein the electron transporting material is a phenylazomethylene-cyclohexadienone derivative of Formula I where A is a nitro group.

5. The electrophotographic photoreceptor as claimed in claim 1, wherein the electron transporting material is a phenylazomethylene-cyclohexadienone derivative of Formula I where A is a cyano group.

6. The electrophotographic photoreceptor as claimed in claim 1, wherein the electron transporting material is a phenylazomethylene-cyclohexadienone derivative of Formula I where A is a sulfone group.

7. The electrophotographic photoreceptor as claimed in claim 1, wherein the charge generating material is present in the charge generating layer in an amount of between 40 wt % and 60 wt %.

8. The electrophotographic photoreceptor as claimed in claim 1, wherein the electron transporting material is present in the charge generating layer in an amount of between 5 wt % and 17 wt %.

9. The electrophotographic photoreceptor as claimed in claim 1, wherein the charge transporting material is a hole transporting material.

10. The electrophotographic photoreceptor as claimed in claim 1, which further comprises an intermediate layer between the conductive substrate and charge-generating layer.

11. The electrophotographic photoreceptor as claimed in claim 1, wherein the photoreceptor is a negatively charged bilayer photoreceptor.

12. An electrophotographic image forming device comprising:
(a) a plurality of supporting rollers; and
(b) an electrophotographic photoreceptor mounted to operate in line with the supporting rollers,
wherein the electrophotographic photoreceptor comprises:
a conductive substrate;
a charge generating layer formed on the conductive substrate and comprising a charge generating material and electron transporting material; and
a charge-transporting layer formed on the charge generating layer and comprising a charge transporting material,
wherein the electron transporting material is a phenylazomethylene-cyclohexadienone derivative represented by the following Formula I: 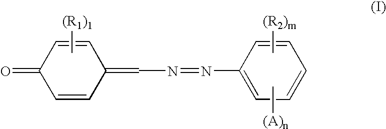
wherein R₁ and R₂ are independently selected from the group consisting of a substituted or unsubstituted C₁-C₂₀ alkyl, substituted or unsubstituted C₁-C₂₀ alkoxy, substituted or unsubstituted C₆-C₃₀ aryl, substituted or unsubstituted C₇-C₃₀ aralkyl and a halogen; A is selected from the group consisting of nitro, cyano and sulfone; 1 is an integer between 1 and 4; m is 0 or an integer between 1 and 4; and n is an integer between 1 and 5.

13. A method of forming an electrophotographic image comprising the steps of:
(a) applying electric potential to a surface of an electrophotographic photoreceptor;
(b) exposing the surface of the electrophotographic photoreceptor to radiation to dissipate the electric charges in selected zones by imaging to form a pattern having a charged zone and non-charged zone on the surface;
(c) contacting the surface with a toner to form a toner image; and
(d) transferring the toner image to a support,
wherein the electrophotographic photoreceptor comprises:
a conductive substrate;
a charge generating layer formed on the conductive substrate and comprising a charge generating material and electron transporting material; and
a charge-transporting layer formed on the charge generating layer and comprising a charge transporting material,
wherein the electron transporting material is a phenylazomethylene-cyclohexadienone derivative represented by the following Formula I: 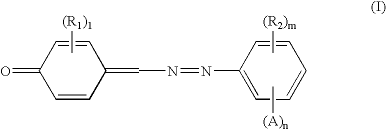
wherein R₁ and R₂ are independently selected from the group consisting of a substituted or unsubstituted C₁-C₂₀ alkyl, substituted or unsubstituted C₁-C₂₀ alkoxy, substituted or unsubstituted C₆-C₃₀ aryl, substituted or unsubstituted C₇-C₃₀ aralkyl and a halogen; A is selected from the group consisting of nitro, cyano and sulfone; 1 is an integer between 1 and 4; m is 0 or an integer between 1 and 4; and n is an integer between 1 and 5.
